(19) United States
(12) Patent Application Publication
(10) Pub. No.: US 2022/0260204 A1
(43) Pub. Date: Aug. 18, 2022

(54) ROTATING MECHANISM WITH LOCKABLE GEAR

(71) Applicant: FNSS SAVUNMA SISTEMLERI A.S., GÖLBASI (TR)

(72) Inventors: AHMET ÇAGKAN ÇEVIK, GÖLBASI (TR); BIROL CANKURTARAN, GÖLBASI (TR); HACI MEHMET AKIN, GÖLBASI (TR)

(21) Appl. No.: 17/275,681

(22) PCT Filed: Sep. 30, 2020
(86) PCT No.: PCT/TR2020/050895

§ 371 Date: Mar. 12, 2021

(30) Foreign Application Priority Data
Oct. 30, 2019 (TR) 2019/16718

(51) Int. Cl. F16M 13/02; F16M 11/10; F16M 11/20; B60R 11/02

(52) U.S. Cl. CPC F16M 13/027; F16M 11/10; B60R 2011/0089; B60R 11/0235; F16M 11/2014

(57) ABSTRACT

The present invention relates to a rotating mechanism with lockable gear that provides safer and more functional mobility within the vehicle for the mechanisms for the display systems mechanism placed in wheeled or tracked military vehicle. The present invention particularly relates to a rotating mechanism with lockable gear comprised of a vertical axial rotating mechanism (100), which rotates display systems placed in wheeled or tracked military vehicles around the vertical axis Y, a horizontal axial rotating mechanism (200), which rotates display systems placed in wheeled or tracked military vehicles around the horizontal axis X and a locking mechanism (300), which immobilizes movement of the display systems by preventing its mobility.

### TECHNICAL FIELD OF THE INVENTION

The present invention relates to a rotating mechanism with lockable gear that ensures safer and more functional mobility within the vehicle for mechanisms for the display systems placed in wheeled or tracked military land vehicle.

The present invention particularly relates to a rotating mechanism with lockable gear, which is comprised of a vertical axial rotating mechanism, which rotates the display systems placed in wheeled or tracked military vehicles around the vertical axis Y, a horizontal axial rotating mechanism, which rotates the display systems placed in wheeled or tracked military vehicles around the horizontal axis X and a locking mechanism, which stabilizes movement of the display systems by preventing its mobility.

### THE STATE OF THE ART

There are significant improvements in military systems in parallel with technological developments. The primary reason underlying these developments is basically the intention to make the military vehicle fast, comfortable, practical and reliable. It is an important matter for military vehicles to be able to get the vision of the outside during operation. Therefore, the team in the vehicle must have a precise angle of vision of the outside of the vehicle. There are several applications to raise the angle of vision. Among them, there are systems that can be used without electronic systems such as protected glass and periscope turrets and also systems that can receive images from the monitor placed inside of the vehicle by means of the camera placed outside of the vehicle. Since the image received from the camera is transferred to the team in the vehicle by means of a monitor, the connection system of the monitor placed in the vehicle has a crucial importance. A variety of methods have been tried for this connection mechanism in Turkey and around the world. The most common implementation among these methods is to use fixed connection mechanism. When mounting these mechanisms in the vehicle, the objective is to adjust the mechanism according to the eye level of the person that uses the monitor. Another connection point is the body part of the vehicle. The connection interface of the monitor prevents the mobility due to its design.

In the state of the art, since the fixed mechanism prevents the mobility due to its design, it increases the volume in the vehicle and substantially decreases the radius of action.

In the state of the art, since it is positioned neglecting the physical features of the person that uses the monitor, it does not ensure an ergonomic use.

In the state of the art, the risk that the monitor is damaged cannot be reduced, because the monitor is still present in the vehicle, even if it is not used.

The fixed mechanisms used in the state of the art are fixed structures that are designed in accordance with the predetermined criteria and data. It does not ensure flexibility in possible alterations and particularly to the users with different physical features. In short, they do not have flexible usage structure.

The patent document numbered EP0942221B1 in the state of the art comprises a different connection design for eliminating the disadvantages of the fixed connection mechanism. However, when the invention is examined, the advantages of the rotating mechanism with lockable gear can be clearly observed. Since the inventive rotating mechanism with lockable gear has less sub-components, it will be less affected by the vibration, when the vehicle is en-route or idling. Furthermore, when the sub-components are examined, it is seen that the rotating mechanism with lockable gear can be manufactured with lower cost. The mounting of the rotating mechanism with lockable gear may be easily performed, since the number of sub-components is lesser in the inventive rotating mechanism with lockable gear. When the mechanisms in the present invention and in the patent document numbered EP0942221B1 are examined, the differences between bearing capacities of two invention can be clearly observed. The rotating mechanism with lockable gear that is more durable may carry higher amounts of load. This ensures the rotating mechanism with lockable gear to be a flexible platform.

As a consequence, in order to bring solution to the problems described above in the state of the art, the need for a novel economic, useful, ergonomic rotating mechanism with lockable gear that provides more functional mobility and also the inefficacy of the present solutions have necessitated to make a novelty in the related technical field.

### OBJECTS OF THE INVENTION

The present invention relates to a rotating mechanism with lockable gear, which is developed for eliminating the aforementioned disadvantages and creates new advantages for the related technical field and ensures safer and more functional mobility within the vehicle for the display systems platform such as “crew display” and “computer system” placed in wheeled or tracked military vehicle.

The main object of the invention is to ensure an increased radius of action in vehicle, since the inventive rotating mechanism with lockable gear is capable of rotating in 2 axes.

Another object of the invention is to ensure an ergonomic use for the user, since the inventive rotating mechanism with lockable gear is lockable in every angle by means of its design.

Another object of the invention is to minimize the risk of screen damage, since user may rotate the mechanism connected to the monitor when it is not in use.

Another object of the invention is to provide an easy mounting process due to the movement of the rotating mechanism with lockable gear in more than one axis.

Another object of the invention is to provide an easy mounting process and maintenance opportunities.

Another object of the present invention is to ensure that the inventive rotating mechanism with lockable gear varies based on user's habits. In other words, it has a flexible structure.

Another object of the invention is to ensure that the inventive rotating mechanism with lockable gear do not have a limited component range due to its flexible structure. The requested mounting of in-vehicle equipment may be mounted to the inventive rotating mechanism with lockable gear. The internal intercom units, external intercom units, control screens and gunner console can be given as examples of in-vehicle equipment.

A rotating mechanism with lockable gear, which is developed to implement all the objects mentioned above and will emerge from detailed description below, wherein it comprises;
a vertical axial rotating mechanism (100) that rotates screen (A) around the vertical axis Y,
a horizontal axial rotating mechanism (200) that rotates it around the vertical axis X,
a locking mechanism (300) that immobilizes the screen (A) by preventing its mobility.

The structural features and characteristics and all advantages of the present invention will be fully understood through the detailed description written by means of the figures given below and referring to said figures, and therefore, the evaluation must be made in accordance with said figures and detailed description.

### BRIEF DESCRIPTION OF THE DRAWINGS

FIG. 1 illustrates the inventive rotating mechanism with lockable gear

FIG. 2 illustrates the inventive rotating mechanism with lockable gear

FIG. 3 illustrates the inventive rotating mechanism with lockable gear

FIG. 4 illustrates the inventive rotating mechanism with lockable gear

FIG. 5 illustrates the inventive rotating mechanism with lockable gear

FIG. 6 illustrates the demounted horizontal axial rotating mechanism of the inventive rotating mechanism with lockable gear

FIG. 7 illustrates the demounted vertical axial rotating mechanism of the inventive rotating mechanism with lockable gear

FIG. 8 illustrates the demounted locking mechanism of the inventive rotating mechanism with lockable gear

FIG. 9 illustrates the demounted inventive rotating mechanism with lockable gear

FIG. 10 illustrates the sectional view of the inventive rotating mechanism with lockable gear, when it is unlocked.

FIG. 11 illustrates the sectional view of the inventive rotating mechanism with lockable gear, when it is locked.

### REFERENCE NUMERALS

A. Screen

100. Vertical Axial Rotating Mechanism

110. Vehicle Mounting Plate (Upper)

111. Mobility-Restrictor Slot

120. Screen Mounting (Lower) Plate

130. Friction Washer

140. Upper Plate Support Bracket

150. Ball Locking Pin (Setscrew)

200. Horizontal Axial Rotating Mechanism

210. Upper Gear Adapter

211. Upper Gear Socket

212. Spring Socket

220. Upper Gear

230. Dawel Pin with Thread

240. Spiral Spring

250. Lower Gear

260. Lower Gear Adapter

261. Lower Gear Socket

270. Pressure Spring

280. Stopper

300. Locking Mechanism

310. Slotted Washer

311. Slot

320. Active Pin

321. Cam Socket

330. Handle

331. Radius Surface

332. Socket

340. Grooved Pin

350. Cam

360. Handle Cover

370. Spring

400. Bolt

500. Connector

### DETAILED DESCRIPTION OF INVENTION

In this detailed description, the preferred embodiments of the inventive rotating mechanism with lockable gear are described without being limited to provide a better understanding of the invention.

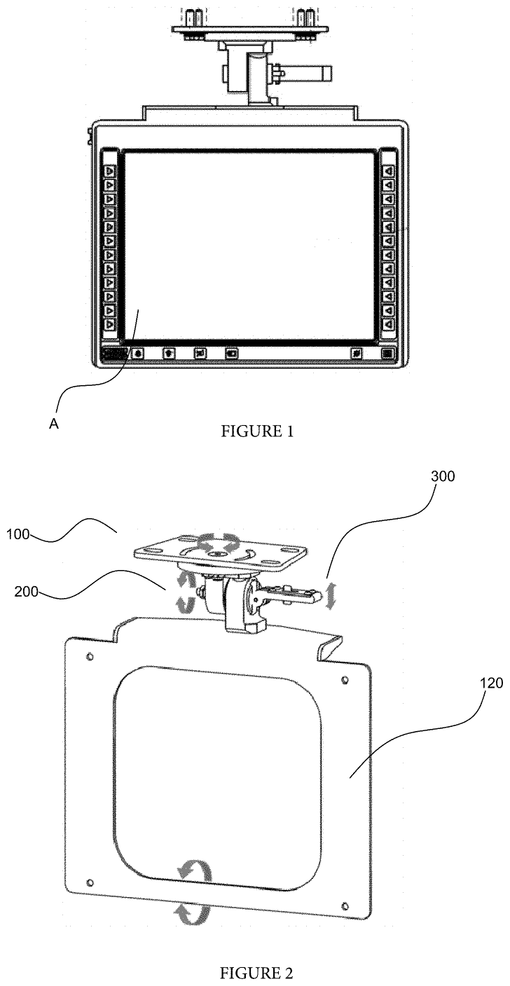

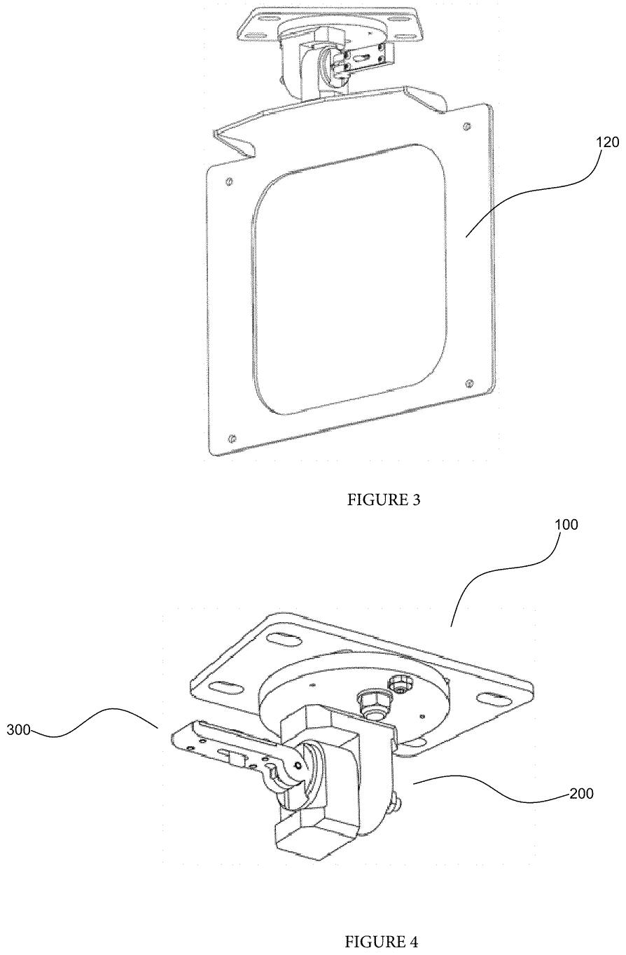

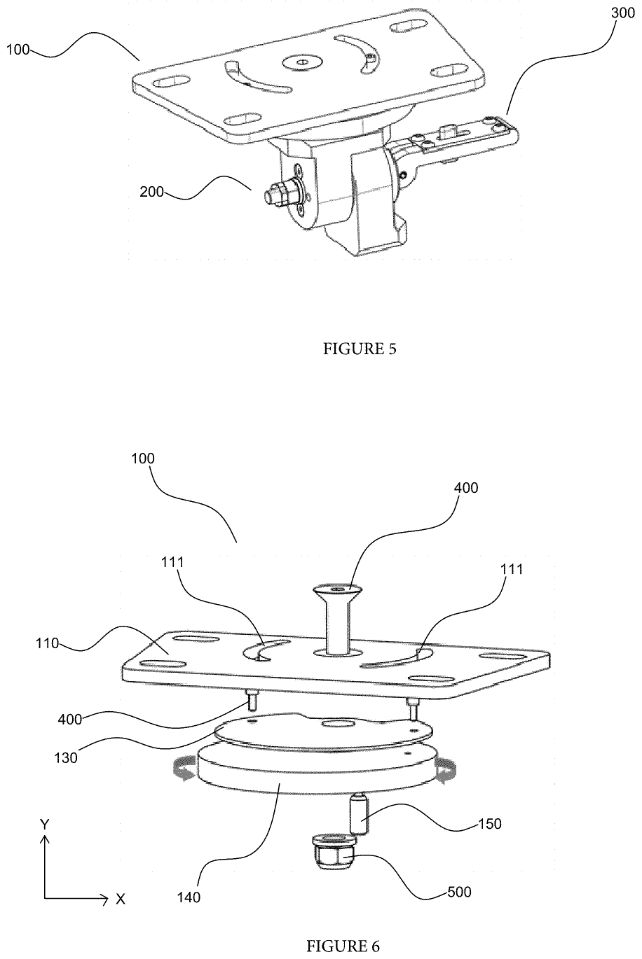

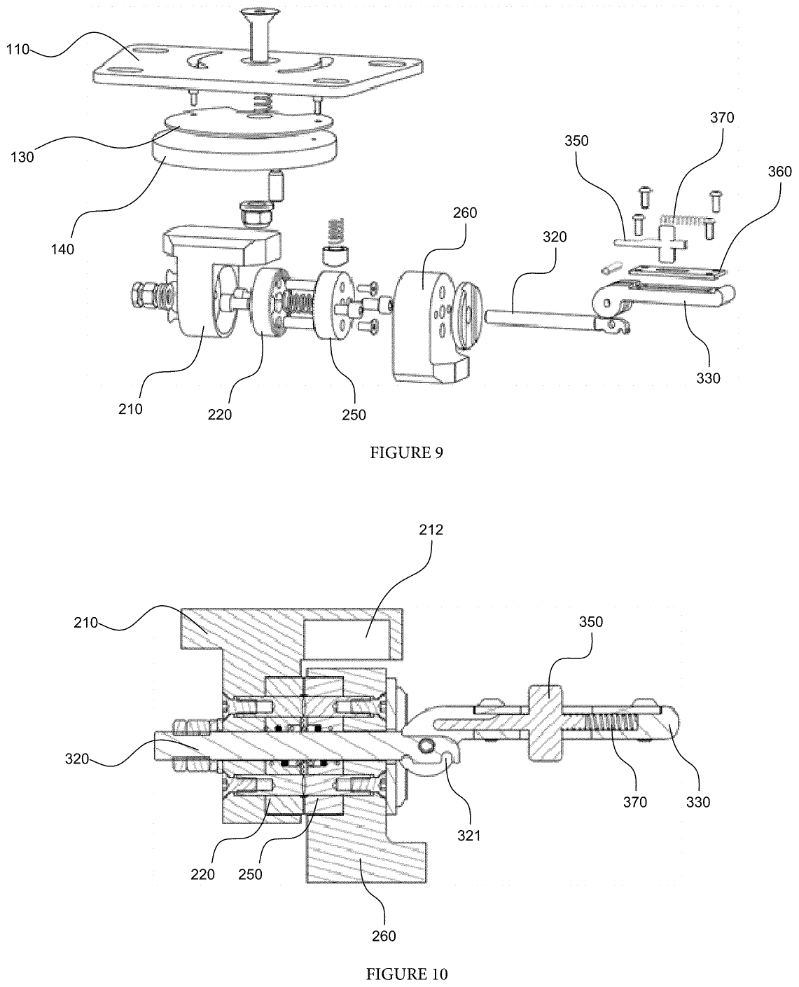

The inventive mechanism with lockable gear is illustrated in FIG. 1, FIG. 2, FIG. 3, FIG. 4 and FIG. 5 and the demounted inventive mechanism with lockable gear is illustrated in FIG. 9. The present invention comprises of vertical axial rotating mechanism (100) that rotates the screen (A) in the vertical axis Y, horizontal axial rotating mechanism (200) that rotates the screen in the horizontal axis X, and locking mechanism (300) that immobilizes the screen (A) by preventing its mobility.

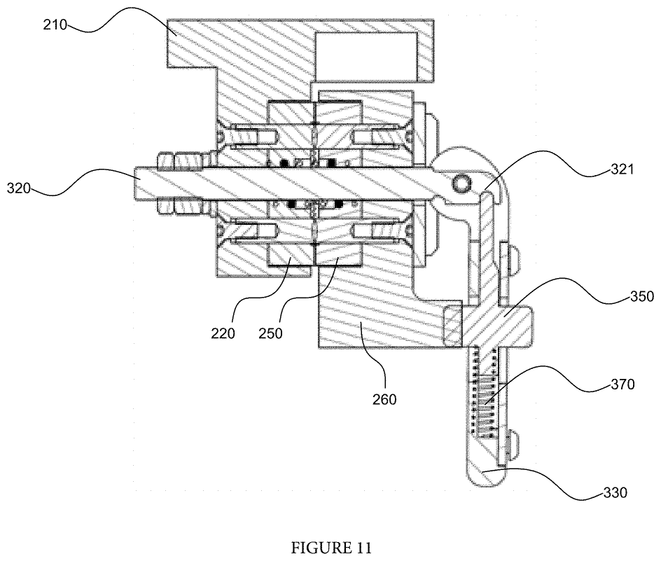

In FIG. 8, the inventive locking mechanism (300) is illustrated when it is demounted. The active pin (320), which is positioned within the gears (220,250) and immobilized by means of a connector (500), is connected to handle (330) by means of a grooved pin (340). As the handle (330) is started to be moved under the force applied by the user, the radius surface (331) of the handle pulls the active pin (320) outwards by applying pressure on the slotted washer (310) while rotating thereon. As a result, the threads are being locked when the gears (220,250) get closer to each other. Thus, it is ensured that the system is fixed. The handle (330) is capable of moving stably and easily by contacting on the slot (311) of slotted washer (310). When rotating process of the handle (330) is ended subsequent to the immobilization of the system, the cam (350) in the socket (332) locks the system by fitting into the cam socket (321). The spring (370) in the socket (332) prevents cam (350) to disengage from the cam socket (321) by applying pressure thereon. FIG. 11 illustrates the system when it is locked. It is ensured that the locked system is unlocked when the handle (330) is rotated by pulling the cam (350) by hand out of the cam socket (321). FIG. 11 illustrates the system when it is unlocked. The handle cover (360) fixed to the handle (330) by means of a bolt (400), prevents cam (350) and spring (370) to be disengaged from the socket (332).

FIG. 6 illustrates the inventive vertical axial rotating mechanism (100). The vehicle mounting plate (110) ensures that the rotating mechanism with lockable gear is connected to the vehicle. As the vehicle mounting plate (110), the friction washer (130) and the upper plate support bracket (140) are connected to each other by means of the bolt (400) and the connector (500), the friction washer (130) and the upper support bracket (140) rotates on the vehicle mounting plate in the axis of the bolt (400). Thus, it is ensured that the screen (A) rotates in the axis Y. The bolt (400) and the connector (500) are tightened at a specified torque value so as to not prevent its movement on the vertical axis Y. Furthermore, even the mechanic lockable connector (500) mostly functions as an intermediate conveyor element on the vertical axial rotating mechanism, it contributes to the movement smoothness when a torque is applied thereon. Owing to the mechanic lockable connector (500), the movement precision smoothness is ensured, and the mechanical gap occurred from external factors such as mounting vibration and shaking may be prevented. The friction washer (130), which is manufactured from materials that have low friction resistance and high abrasion resistance such as castermid, kestoil, polyamide and engineering plastics, smoothly reflects the movement precision by minimizing the friction between vehicle mounting plate (110) and the upper plate support bracket (140). As the friction washer (130) is connected to the upper support bracket (140) by means of the bolt (400), the same bolt (400) limits the rotation movement “Y” of the upper plate support bracket (140) along the mobility-restrictor slot (111) on the vehicle mounting plate (110) in the vertical axis. The ball lock pin (150), immobilizes the upper plate support bracket (140) to its position “Y” in the vertical axis in accordance with the screen operator's angle of visibility within the vehicle. In short, it gradually creates a locking/immobility state in vertical axial rotating mechanism

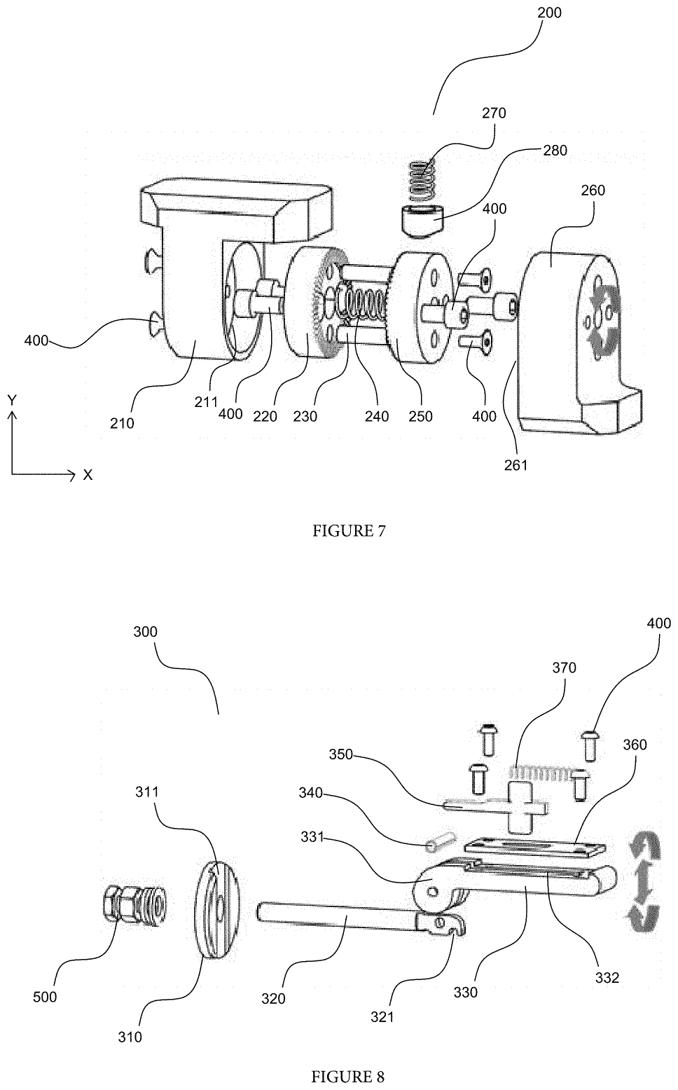

FIG. 7 illustrates the inventive horizontal axial rotating mechanism (200). The upper gear (220) is positioned in the upper gear socket (211) of the upper gear adapter (210) connected to the upper plate support bracket (140) and it is fixed to the upper gear adapter (210) by means of the bolt (400). Similarly, the lower gear (250) is positioned in the lower gear socket (261) of the lower gear adapter (260) connected to the screen mounting plate (120) on which the display elements such as screen (A) is mounted and it is fixed to the lower gear adapter (260) by means of the bolt (400). The spiral spring (240) placed on the active pin (320), which ensures that the gears are connected to each other when the locking mechanism (300) is unlocked, ensures that the lower gear (250) and the upper gear (220) rotate on the threads thereon by pushing them on opposite directions. Thus, the lower gear adapter part (260), which is rotated by means of the gears (220, 250), allows the screen (A) to be adjusted by rotating it in the axis X as desired. Also, the spiral spring (240) ensures that the position “X” of the upper gear (220) and the lower gear (250) in the horizontal axis is stable. The dawel pin with thread (230), which is connected to the gears (220,250) by means of the bolts (400), precisely immobilizes and centers the gears (220,250) to the adapters (210, 260). They ensure that the threads are correctly fitted against each other and therefore the locking process can be implemented properly. The pressure spring (270) positioned on the spring socket (212) pushes down the stopper (280) by its pressure force and, thus it ensures that the stopper (280) applies pressures on the lower gear adapter (260) and the position “X” of the screen mounting plate (120) in the horizontal axis remains stable.

The protection scope of this application is specified in Claims and cannot be limited to those described above for illustrative purposes, it is evident that a person skilled in the art can deliver the novelty of the invention by using the similar embodiments and/or implement this embodiment to other technical fields that has similar objects. Therefore, it is evident that such embodiments will lack the overcoming the criteria of novelty and especially the state of the art.

1- Rotating mechanism with lockable gear that provides safer and more functional mobility within the vehicle for the display systems mechanism placed in wheeled or tracked military vehicle, characterized in that, it comprises;
at least one vertical axial rotating mechanism (100) that rotates the display system or the screen (A) around the vertical axis Y,
at least one horizontal axial rotating mechanism (200) that rotates it around the vertical axis X,
at least one locking mechanism (300) that immobilizes the display system or the screen (A) by preventing their mobility.

2- A vertical axial rotating mechanism (100) according to claim 1, characterized in that; it comprises an upper plate support bracket (140) connected to the vehicle mounting plate (110) together with the friction washer (130) by means of the bolt (400) and the connector (500), which ensures that the system moves in the axis Y by rotating in the axis of the bolt (400).

3- A vertical axial rotating mechanism (100)according to claim 1, characterized in that; it comprises a friction washer (130), which reflects the movement precision smoothly by minimizing the friction between the vehicle mounting plate (110) manufactured from materials that have low friction resistance and high abrasion resistance such as castermid, kestoil, polyamide and engineering plastics and the upper plate support bracket (140).

4- A vertical axial rotating mechanism (100) according to claim 1, characterized in that; it comprises a vehicle mounting plate (110), which ensures that the rotating mechanism with lockable gear is connected to the vehicle.

5- A vertical axial rotating mechanism (100) according to claim 1, characterized in that; it comprises a mechanic lockable connector (500) that prevents the mechanical gap occurred from external factors such as mounting vibration and shaking.

6- A vertical axial rotating mechanism (100) according to claim 1, characterized in that; it comprises a mobility-restrictor slot (111) that restricts the rotation movement “Y” of the upper plate support bracket (140) in the vertical axis.

7- A vertical axial rotating mechanism (100) according to claim 1, characterized in that; it comprises a ball locking pin (150) that immobilizes the position “Y” of the upper plate support bracket (140) in the vertical axis in accordance with the screen (A) operator's angle of visibility within the vehicle.

8- A horizontal axial rotating mechanism (200)according to claim 1, characterized in that; it comprises an upper gear adapter (210), which is connected to the upper plate support bracket (140) has an upper gear (220) positioned in its upper gear socket (211) and immobilized by means of the bolt (400).

9- A horizontal axial rotating mechanism (200)according to claim 1, characterized in that; it comprises a lower gear adapter (260), which is connected to the screen mounting plate (120) on which the display elements such as screen (A) is mounted, on which the lower gear (250) is positioned on the lower gear socket (261) and which is immobilized by a bolt (400), that allows screen (A) to be adjusted by rotating it in the axis X as desired.

10- A horizontal axial rotating mechanism (200)according to claim 1, characterized in that; it comprises a spiral spring (240) placed on the active pin (320), which ensures that the gears (220, 250) are connected to each other when the locking mechanism (300) is unlocked, ensures that the lower gear (250) and the upper gear (220) rotate on the threads thereon by pushing them on directions.

11- A horizontal axial rotating mechanism (200)according to claim 1, characterized in that; it comprises an dawel pin with thread (230), which is connected to the gears (220,250) by means of the bolts (400), precisely immobilizes and centers the gears (220,250) to the adapters (210, 260).

12- A horizontal axial rotating mechanism (200)according to claim 1, characterized in that; it comprises a stopper (280), which ensures that the pressure spring (270) positioned on the spring socket (212) pushes down the stopper by means of the pressure force, and applies pressure to the lower gear adapter (260), thereby stabilizing the position “X” of the screen mounting plate (120) on the horizontal axis.

13- A locking mechanism (300) according to claim 1, characterized in that; it comprises an active pin (320), which is positioned within the gears (220,250) and immobilized by means of a connector (500) and which is connected to the handle (330) by means of a grooved pin (340) and locks and unlocks the gears (220, 250) by moving back and forth.

14- A locking mechanism (300) according to claim 1, characterized in that; it comprises a radius surface (331) and a handle (330), which mobilizes the active pin (320) by pulling it outwards by applying pressure on the slotted washer (310) while rotating thereon as the handle is started to be moved under the force applied by the user.

15- A locking mechanism (300) according to claim 1, characterized in that; it comprises a slotted washer (310), which ensures that the handle (330) moves stably and easily on the slot (311).

16- A locking mechanism (300) according to claim 1, characterized in that; it comprises a cam (350), which is pulled by hand for unlocking, positioned in the socket (332) and locks the system by entering the cam socket (321) when the rotating process of the handle (330) is completed after ensuring the immobilization of the system.

17- A locking mechanism (300) according to claim 1, characterized in that; it comprises a spring (370) positioned in the socket (300) that prevents cam (350) to disengage from the cam socket (321) by applying pressure thereon.
